(19) United States
(12) Patent Application Publication
(10) Pub. No.: US 2009/0274864 A1
(43) Pub. Date: Nov. 5, 2009

(54) Process for using polyurethane resin to coat a plurality of sequins attached to a material

(76) Inventor: Chung Ching Tsai, Taoyuan City (TW)

Correspondence Address: Mr. Hung Ban Tran, Suite 205A, 228 W. Valley Blvd., Alhambra, CA, 91801, US

(21) Appl. No.: 12/069,760

(22) Filed: May 2, 2008

(51) Int. Cl. B05D 3/02; B32B 3/06

(52) U.S. Cl. 428/102; 427/372.2

(57) ABSTRACT

A method of coating a roll of material with a plurality of sequins comprising steps of (1) passing a roll of material with a plurality of sequins with the sequins on an upper surface of said roll of material through two wooden guards; (2) passing said roll of material with a plurality of sequins with the sequins on said upper surface of said roll of material through a coating device, (3) passing said roll of material with a plurality of sequins with the sequins on said upper surface of said roll of material through a scrapper device to ensure the evenness of said roll of material; (4) passing said roll of material with a plurality of sequins with the sequins on said upper surface of the material through a drying room; and (5) rolling said roll of material into a second roll through a roller. This method is repeated four times to ensure that the material will be able to pass the physical and mechanical tests imposed by the Consumer Product Safety Commission.

### BACKGROUND

This invention relates to a process for using polyurethane (PU) resin to coat a plurality of sequins attached to a roll of material (such as a fabric, leather or any like material), evening the resin and controlling the coating thickness. This invention provides a process of coating the PU resin onto the sequins attached to a roll of material so that the edges of the sequins residing on the roll of material will not protrude upwards.

Generally, a plurality of sequins attached to a material is applied on the external surfaces of shoes or purses. The shininess of the sequins serves as a very attractive device so that the shoes or purses are very noticeable to people in the vicinity of the shoes or purses. The sequins attached to a material are usually sewn or stitched onto the surface of the material. One of the methods is as shown in U.S. Pat. No. 5,562,057 by Harry Hanson in 1996 for stitching the sequins onto a fabric. The edges of the sequins sometimes protrude outwards and could be hazardous to the one who wears the shoes or the purse. In addition, many traditional methods of placing sequins on shoes have not been able to pass the 15 lb pull test imposed by the Consumer Product Safety Commission. A conventional method to solve this problem is to apply a thin thermoplastic urethane (TPU) film on top of the plurality of sequins attached to a material. This resultant material with this thin film applied onto the shoes or purses produces an uneven surface with bubbles, wrinkles and cracks within a short period of time. The TPU film also does not stick to the sequins and makes the shoe look too plastic in appearance.

The objective of this invention is to offer a method for coating a polyurethane resin onto a plurality of sequins attached to a material. Through this method, the edges of the sequins on the material with will not protrude outwards or upwards from the material. The method comprises stretching the roll of sequins attached to a material so that no wrinkles are on the roll, guiding the roll to a coating device, pouring a thin layer of polyurethane resin onto a plurality of sequins attached to the roll of material, and using a scrapper to scrape on the PU resin on top of the sequins to further ensure the evenness of the layer of PU resin. The method further comprises passing the plurality of sequins on the roll through a drying room and storing the roll into a second roll. This method is repeated four times to ensure that the layers of PU resin on the plurality of sequins attached to a roll of material provides enough strength on the sequins and the roll to pass the physical and mechanical tests imposed by the Consumer Product Safety Commission.

It is therefore an object of this invention to provide a method for coating a layer or layers of PU resin onto a plurality of sequins attached to a material or a roll of material. The PU resin will settle on the sequins as well as the material or a roll of material.

It is also an object of this invention to provide a method for coating a layer of PU resin onto a plurality of sequins attached to a material or a roll of material such that the layer of PU resin will be evenly distributed onto the surface of the sequins as well as the material or the roll of material. It is a further object of this invention to provide a method for coating a layer or layers of PU resin onto a plurality of sequins attached to a material or a roll of material such that the layer or layers of PU resin will be distributed evenly at the lateral edges of the material or the roll of material where the plurality of sequins are attached to.

It is still a further object of this invention to provide a method to dry a layer or layers of PU resin coated onto a plurality of sequins attached to a material or a roll of material such that the layer or layers of PU resin will be dried before being rolled into a new roller.

### SUMMARY OF THE INVENTION

The objective of this invention is to offer a method for coating a layer or layers of PU resin onto a plurality of sequins attached to a material or a roll of material. Through this method, the edges of the plurality of sequins on the material will not protrude outwards from the material. A method of coating a layer or layers of PU resin onto a material or a roll of material with a plurality of sequins attached to the material comprising of steps of (1) passing the material or the roll of material with a plurality of sequins attached to the material or the roll of material with the sequins on an upper surface of said roll of material through two wooden guards; (2) pouring PU resin onto said a plurality of sequins attached to the roll of material with the sequins on said upper surface of said roll of material, (3) passing said roll of material through a scrapper device to ensure the evenness of the PU resin on said roll of material; (4) passing said roll of material through a drying room; (5) rolling said roll of material into a second roll through a roller. This method is repeated four times to ensure that the material will be able to pass the physical and mechanical tests imposed by the Consumer Product Safety Commission

### BRIEF DESCRIPTION OF THE DRAWINGS

FIG. 1 is a perspective view of a process for coating PU resin onto a material with a plurality of sequins.

FIG. 2 is a alternative perspective view of an alternative process for coating PU resin onto a material with a plurality of sequins.

FIG. 3 is an illustration of resin being poured onto the material.

FIG. 4 is an illustration of a drying room.

FIG. 5 is an alternative illustration of a drying room with holes on one of the walls of the drying room blowing air into the drying room.

### DETAILED DESCRIPTION OF THE INVENTION

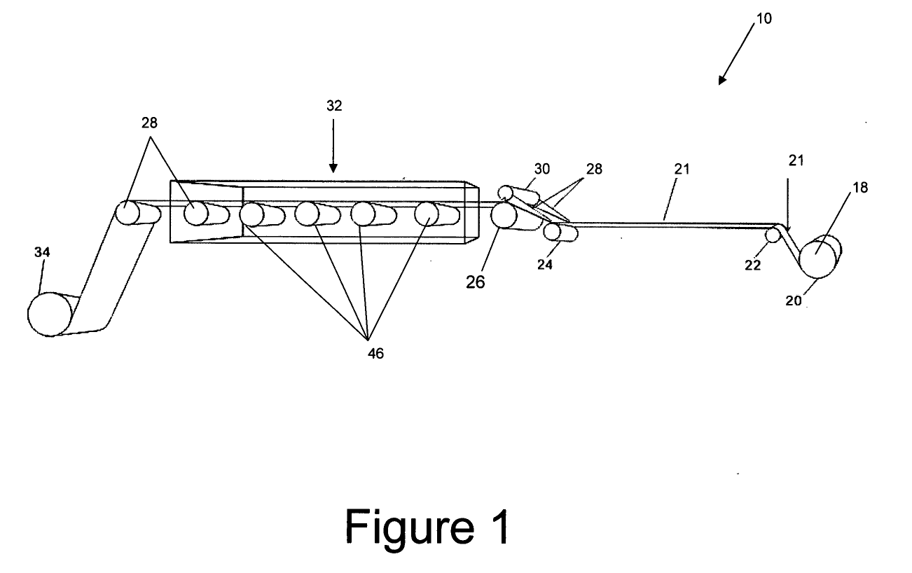

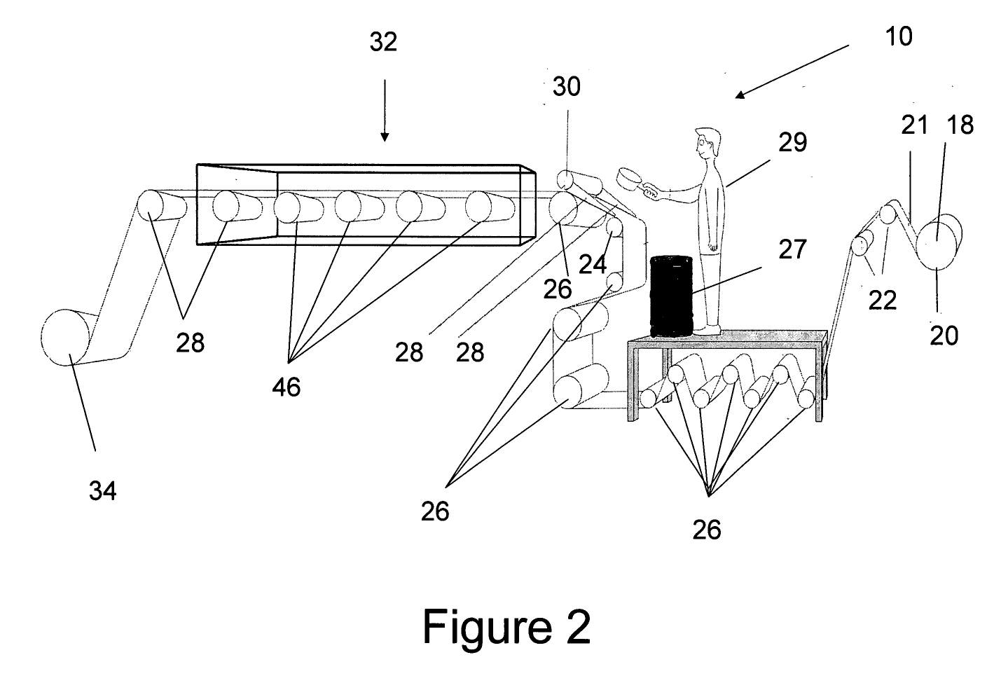

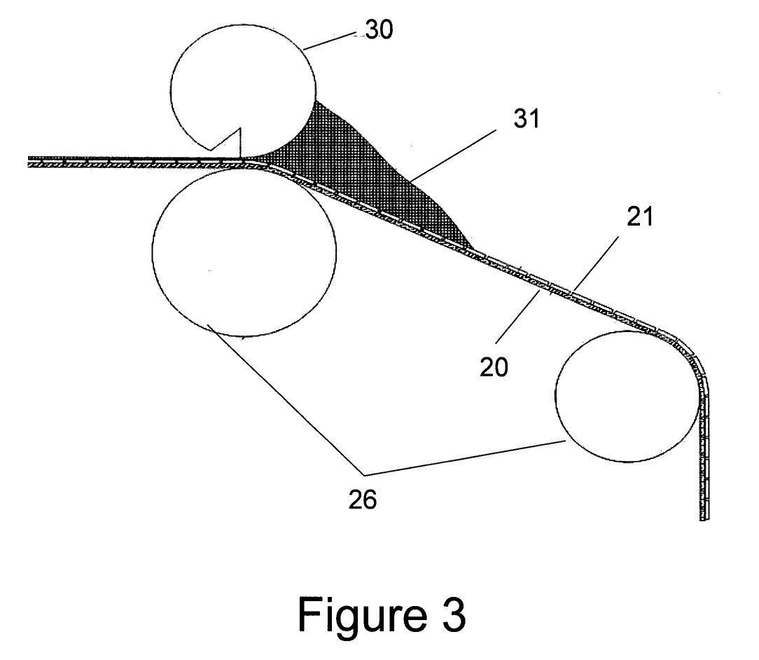

FIG. 1 shows an illustration of a process 10 for using PU resin to coat a plurality of sequins attached to a roll of material. The composition of the sequins is polyester. The sequins are a product of petroleum and a kind of plastic. The sequins come in many shapes, including round, square, star, moon and many more and in many diameters, including 3 mm, 4 mm, 5 mm, 15 mm and more. In the market, sequins have a thickness of about 0.15 mm, although the thickness may vary according to needs. A roll of material 20 with a plurality of sequins 21 attached to the roll of material 20 is to be fed from a roller 18 through a pair of open rollers 22 to open up the sequins and eliminate wrinkles. The roll of material 20 is then transported by at least one transportation roller 24 and being fed into a set of guiding devices 28, which guides the roll of material 20 through a second transportation roller 26 to a scrapper 30. The set of guiding devices 28 also prevents the PU resin 31 from dripping to the floor as shown in FIGS. 2 and 3. If the guiding devices 28 is not used only one of the transportation roller 24 or 26 is needed. The speed of the roll of material 20 that rolls into the set of guiding devices 28 is about 10 yards per minute. The set of guiding devices 28 is comprised of a flat rectangular surface having two upward sides as shown in FIGS. 1 and 2. PU resin 31 is then manually poured on the sequins 21 attached to the roll of material 20 as shown in FIGS. 2 and 3. The speed at which PU resin 31 is poured is determined visually and the speed the at which the PU resin 31 is poured is about the speed of the roll of material 20 carrying the sequins 21. There is no problem if PU resin is “over poured” because the scrapper 30 will even out the PU resin 31 and spread it onto the roll of material 20 that rolls in. Only if PU resin 31 is excessively “over poured” will it drip on the floor. The scrapper 30 with an opening resting behind the set of guiding devices 28 scrapes the sequins 21 on the top surface of the roll of material 20 to even out the PU resin 31 coated onto the sequins 21 and the roll of material 20. The excessive PU resin 31 stays inside of the opening and spreads it onto the roll of material 20 that rolls in. The roll of material 20 is then fed into a drying room 32, where the PU resin will be dried out before being rolled into a second roller 34.

FIG. 2 shows an alternative illustration of how the PU Resin 31 is poured onto the sequins 21 attached to a roll of material 20; and how a plurality of transportation rollers 26 and 24 are being used to transport the roll of material 20 from the open rollers 22 to the set of guiding devices 28. A person 29 pours PU resin 31 onto the sequins 21 attached to a roll of material 20.

FIG. 3 shows an illustration of the detail of a scrapper 30 used to even out the PU resin 31 coated on the top surface of the roll of material 20 and the sequins 21.

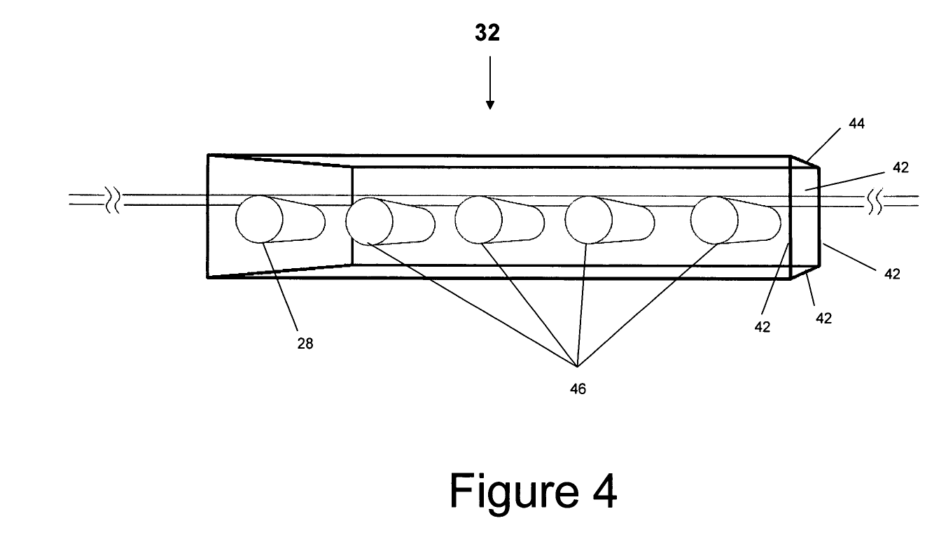

FIG. 4 shows an illustration of a 32 comprising a hollow rectangular tunnel 42 having four walls 44. A plurality of round rollers 46 exists inside the hollow rectangular tunnel 42, with each end mounted on a side wall of the hollow rectangular tunnel 42, wherein the roll of material 20 rests on the round rollers 46 when moving into and out of the hollow rectangular tunnel 42. The roll of material when moving out of the rectangular hollow tunnel 42 is being rolled into a second roller 34 through transportation rollers 28.

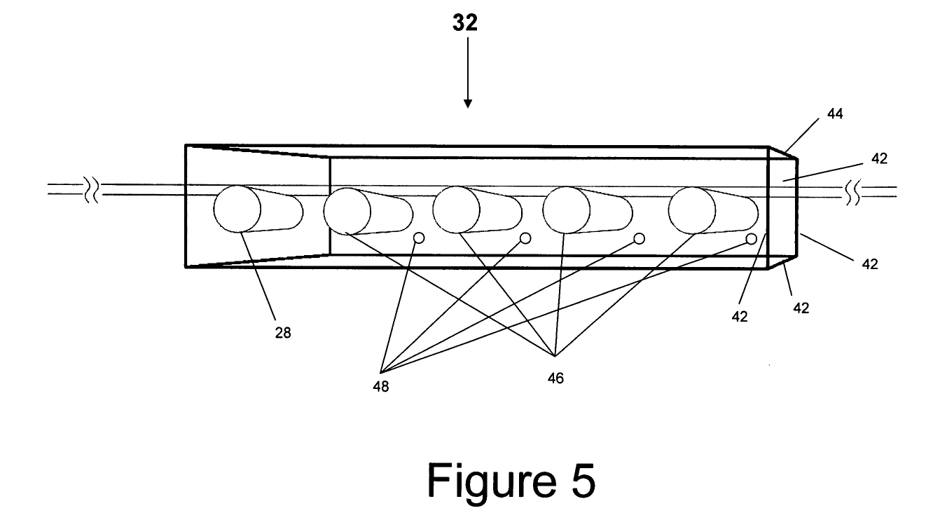

FIG. 5 shows an illustration of alternative drying room 32 comprised of a hollow rectangular tunnel 42 having four walls 44. The polyurethane resin 31 once applied to the sequins, needs to be heated up to 120 to 130 degrees Celsius to dry. Inside the hollow rectangular tunnel 42, there are a plurality of round rollers 46 with each end mounted on a wall of the hollow rectangular tunnel 46, wherein the roll of material 20 rests on the round rollers 46 when moving into and out of the hollow rectangular tunnel 46. The roll of material 20 when moving out of the tunnel is being rolled into a second roller through transportation rollers 28. A plurality of holes 48 exist on one of the walls of the tunnel, where air is being blown into the tunnel to speed up the drying of the PU resin process.

The process of coating PU resin 31 onto a plurality of sequins 21 attached to a roll of material 20 begins with a roll of material 20 with sequins 21 attached to it being fed to a pair of open rollers 22, where the open rollers 22 stretch and spread the roll of material 20 eliminating the wrinkles on the roll of material 20 before being coated with PU resin 31 as shown in FIGS. 1, 2 and 3. The roll of material 20 is transported by transportation rollers 26 and 24 and then fed through a set of guiding devices 28, where the roll of material 20 is being guided into the scrapper 30 (See FIG. 1). Prior to being scrapped by the scrapper 30, the PU resin 31 is poured onto the sequins 21 attached to the roll of material 20, where the PU resin 31 is coated onto the sequins 21 and the roll of material 20 in a way similar to a printing press (see FIG. 3). The PU resin 31 can be poured manually (see FIG. 2) or fed into a machine which coats the roll of material (not shown). A scrapper 30 is located behind the set of guiding devices 28 to even out the thickness of the PU resin 31 being coated onto the sequins 21 and the roll of material 20. The scrapper 30 rolls off any excess PU resin from the surface of the coated roll of material 20 to leave an even coating after the roll of material 20 passes through the scrapper. The set of guiding devices 28 prevents the excessive PU resin 31 from dripping to the floor. At this time, the PU resin 31 is still wet. The roll of material 20 is then fed into a hollow rectangular tunnel 42 having four walls 44. A plurality of rigid round rods 46 exists in the tunnel, with each end mounted on a wall of the hollow rectangular tunnel 42, wherein the roll of material 20 rests on the round rollers 46 when moving into and out of the hollow rectangular tunnel 42. There exists a plurality of holes 48 on one of the four walls 44 of the hollow rectangular tunnel 42. Air is being blown into the hollow rectangular tunnel 42 to speed up the process of drying for the PU resin 31 on the roll of material 20. The roll of material 20 is then rolled into a second roller 34.

When the roll of material 20 with the sequins 21 attached to the roll of material 20 is fed through this process, the sequins 21 begin to stay on the roll of material 20 without the edges of the sequins 21 sticking outwards. This process provides PU resin forming a smooth surface on the roll of material 20 filling up a gap or a plurality of gaps that may exist due to said plurality of sequins 21 attached to the roll of material 20. If coated four times using this process, the roll of material 20 will be able to pass the physical and mechanical tests imposed by the Consumer Product Safety Commission. Each layer of the PU resin is about 0.15 mm thick depending on: customer requests. Coating the roll of material four times also eliminates any air bubbles that may be in the PU resin, and thus creates a more shiny look. Additionally, the extra layers make the coating stronger and more resistant to breakage when the roll of material is bent.

While the embodiments of the present invention have been described, it should be understood that various changes, adaptations, and modifications may be made therein without departing from the spirit of the invention and the scope of the claims.

I claim:

1. A process of coating PU resin onto a roll of material with a plurality of sequins attached to said roll of material, said roll of material having a top surface and a bottom surface and having said plurality of sequins on said top surface of said roll of material, comprising steps of:
(1) passing said roll of material at a passing speed through at least one open roller with said bottom surface of said roll of material touching said at least one open roller;
(2) transporting said roll of material by at least one transportation roller; and
(3) pouring PU resin onto said roll of material and onto said plurality of sequins attached to said top surface of said roll of material, whereby the rate of pouring PU resin is about said passing speed.

2. A process of coating PU resin onto a roll of material with a plurality of sequins attached to said roll of material in claim 1 further comprises scrapping PU resin on said roll of material and PU resin on said plurality of sequins so that a uniform layer of PU resin is formed on said roll of material and said plurality of sequins.

3. A process of coating PU resin onto a roll of material with a plurality of sequins attached to said roll of material in claim 1 further comprises a set of guiding devices to guide said roll of material into a zone on a second transportation roller whereby said pouring of resin onto said roll of material be performed uniformly; said set of guiding devices further preventing excessive PU resin from dripping to a floor.

4. A process of coating PU resin onto a roll of material with a plurality of sequins attached to said roll of material, said roll of material having a top surface and a bottom surface and having said plurality of sequins on said top surface of said roll of material, comprising steps of:
(1) passing said roll of material through at least one open roller with said bottom surface of said roll of material touching at least one open roller;
(2) transporting said roll of material by at least one transportation roller;
(3) pouring PU resin onto said roll of material and onto said plurality of sequins attached to said top surface of said roll of material, whereby the rate of pouring PU resin is about said passing speed;
(4) scrapping PU resin on said roll of material and PU resin on said plurality of sequins so that a uniform layer of PU resin is formed on said roll of material and said plurality of sequins; and
(5) utilizing drying means to dry said layer of PU resin on said top surface of said roll of material.

5. A process of coating PU resin onto a roll of material with a plurality of sequins attached to said roll of material, said roll of material having a top surface and a bottom surface and having said plurality of sequins on said top surface of said roll of material, comprising steps of:
(1) passing said roll of material through at least one open roller with said bottom surface of said roll of material touching the surface of said at least one open roller;
(2) transporting said roll of material by at least one transportation roller;
(3) pouring PU resin onto said roll of material and onto said plurality of sequins attached to said top surface of said roll of material, whereby the rate of pouring PU resin is about said passing speed;
(4) scrapping PU resin on said roll of material and PU resin on said plurality of sequins, whereby PU resin forming a smooth surface on said roll of material filling up a gap or a plurality of gaps that may exist due to said plurality of sequins attached to said roll of material;
(5) utilizing drying means to dry said layer of PU resin on said top surface of said roll of material; and
(6) repeating steps (1) through (5) three times using said roll of material.

6. A material used for decoration of shoes or purses comprising,
(1) a roll of material having a top surface and a bottom surface;
(2) a plurality of sequins attached to said top surface; and
(3) at least one layer of polyurethane resin coated on said plurality of sequins and said top surface, whereby said layer of polyurethane resin forming a smooth surface on said roll of material filling up a gap or a plurality of gaps that may exist due to said plurality of sequins attached to said roll of material.
